(19) United States
(12) Patent Application Publication
(10) Pub. No.: US 2013/0229566 A1
(43) Pub. Date: Sep. 5, 2013

(54) IMAGE PICKUP APPARATUS

(71) Applicant: Keita Kaifu, Tokyo (JP)

(72) Inventor: Keita Kaifu, Tokyo (JP)

(73) Assignee: SONY CORPORATION, Tokyo (JP)

(21) Appl. No.: 13/821,709

(22) PCT Filed: Oct. 20, 2011
(86) PCT No.: PCT/JP2011/074102

§ 371 Date: May 20, 2013

(30) Foreign Application Priority Data
Oct. 29, 2010 (JP) 2010-243259

(51) Int. Cl. H04N 5/225

(52) U.S. Cl. CPC H04N 5/2254
USPC 348/360

(57) ABSTRACT

There is provided an image pickup apparatus that is capable of being reduced in size when a barrel unit including a dimming device is used. An image pickup apparatus 1 includes a barrel unit 2 that emits incident image-pickup light after bending the optical path of the image-pickup light, and an image pickup device 3 that detects the image-pickup light emitted from the barrel unit 2 to obtain an image pickup signal. The barrel unit 2 has a dimming device (a liquid crystal dimming device 26) in a bending region of the optical path of the image-pickup light. As compared with an existing image pickup apparatus in which the dimming device is disposed in a region (on an optical path between the bending region and the image pickup device 3) on the image pickup device 3 side in the barrel unit, a length of an optical path (a length of a lens) of the image-pickup light up to the image pickup device 3 is reduced by an amount of the installation space of the dimming device.

### TECHNICAL FIELD

The present disclosure relates to an image pickup apparatus including a bending (folding) type barrel unit.

### BACKGROUND ART

In an image pickup apparatus such as a digital camera (a digital still camera), to achieve reduction in size (reduction in thickness), a bending (folding) type barrel unit (a lens barrel unit) is generally used (see, for example, PTL 1). In the bending type barrel unit, a prism is disposed behind an objective lens (on a light emission side), and an optical path of image-pickup light is bent (folded) by 90 degrees by using the prism.

In the bending type barrel unit, an iris diaphragm mechanically performing dimming operation (light amount adjustment) is usually provided as a dimming device adjusting the amount of image-pickup light detected by an image pickup device. When the iris diaphragm is used as a dimming device, however, an installation space for iris blades and an installation space for a driving mechanism thereof are both made large. Therefore, it is disadvantageous in size reduction (in thickness reduction) of the barrel unit. In addition, in the iris diaphragm, reduction in resolution due to deterioration of diffraction at the time of slight stop of the iris is controversial.

Accordingly, an electrical dimming device (a liquid crystal dimming device) using a guest-host (GH) type liquid crystal containing dichroic pigment has been proposed as an alternate function of such a mechanical iris diaphragm (see, for example, PTL 2).

### CITATION LIST

### Patent Literature

PTL 1: Japanese Unexamined Patent Application Publication No. 2010-26007

PTL 2: Japanese Unexamined Patent Application Publication No. 2002-82358

### SUMMARY

Incidentally, in the existing bending type barrel unit, the above-described liquid crystal dimming device is disposed in a region on the image pickup device side (on an optical path between the prism and the image pickup device) in the barrel unit. In other words, the liquid crystal dimming device is disposed as it is in a provided region of the existing iris diaphragm.

Therefore, although the barrel unit is reduced in size compared with the barrel unit using the mechanical iris diaphragm, it is insufficient to achieve further reduction in size, and there is a room for improvement. Specifically, in the configuration in a related art, even if the liquid crystal dimming device itself is reduced in thickness by optimization of the components thereof and the like, the length of the optical path (the length of the lens) of the image-pickup light up to the image pickup device is increased by an amount of the installation space of the liquid crystal dimming device. Accordingly, in the image pickup apparatus using the existing bending type barrel unit, size reduction thereof is limited when the dimming device is disposed in the barrel unit.

The present disclosure is made to solve the above-described issues, and it is an object of the disclosure to provide an image pickup apparatus capable of achieving size reduction in the case of using a barrel unit including a dimming device.

An image pickup apparatus according to an embodiment of the disclosure includes: a barrel unit emitting incident image-pickup light after bending an optical path of the image-pickup light; and an image pickup device detecting the image-pickup light emitted from the barrel unit to obtain an image pickup signal. The barrel unit includes a dimming device in a bending region of the optical path.

In the image pickup apparatus according to the embodiment of the disclosure, the dimming device is provided in the bending region where the optical path of the image-pickup light that has entered the barrel unit is bent. Therefore, as compared with the existing image pickup apparatus in which a dimming device is disposed in a region on an image pickup device side (on an optical path between the bending region and the image pickup device) in the barrel unit, the length of the optical path (the length of a lens) of the image-pickup light up to the image pickup device is reduced by an amount of the installation space of the dimming device.

In the image pickup apparatus according to the embodiment of the disclosure, the above-described barrel unit may include a tubular member and a prism disposed in the above-described bending region in the tubular member, as well as the above-described dimming device may be disposed in a gap between an internal surface of the tubular member and the prism. In the case of such a configuration, unlike the existing image pickup apparatus described above, it is unnecessary to provide a space dedicated (a dedicated space) for disposing the dimming device. In other words, since the light dimming device is disposed in the gap as a dead space between the internal surface of the tubular member and the prism, such a dedicated space is unnecessary.

According to the image pickup apparatus of the embodiment of the disclosure, the dimming device is provided in the bending region where the optical path of the image-pickup light that has entered the barrel unit is bent. Therefore, the length of the optical path (the length of the lens) of the image-pickup light is set to be shorter than that in a related art, thereby reducing the size (the thickness) of the configuration of the barrel unit. Consequently, it is possible to achieve size reduction (thickness reduction) of the image pickup apparatus that uses the barrel unit including the dimming device.

### BRIEF DESCRIPTION OF DRAWINGS

FIG. 1 is a perspective view illustrating a configuration example of an appearance of an image pickup apparatus according to an embodiment of the disclosure.

FIG. 2 is a perspective view illustrating a configuration example of an appearance of a barrel unit illustrated in FIG. 1.

FIG. 3 is a diagram illustrating a configuration example of an optical system in the barrel unit and others illustrated in FIG. 1.

FIG. 4 is a sectional diagram illustrating a part of the barrel unit illustrated in FIG. 3, in an enlarged manner.

FIG. 5 is a schematic sectional diagram illustrating a detailed configuration example of a liquid crystal dimming device illustrated in FIG. 4.

FIG. 6 is a block diagram illustrating a configuration example of a control processing section and others in the image pickup apparatus illustrated in FIG. 1.

FIG. 7 is a schematic sectional diagram for explaining a function of the liquid crystal dimming device illustrated in FIG. 5.

FIG. 8 is a characteristic diagram illustrating an example of a relationship between a voltage application rate and a transmittance of the liquid crystal dimming device illustrated in FIG. 5.

FIG. 9 is a diagram illustrating a configuration example of an optical system in an image pickup apparatus provided with a barrel unit according to a comparative example.

FIG. 10 is a sectional diagram illustrating a part of the barrel unit illustrated in FIG. 9 in an enlarged manner.

FIG. 11 is a characteristic diagram illustrating an example of a relationship between an elapsed time after startup of an image pickup apparatus and a temperature.

FIG. 12 is a schematic sectional diagram illustrating a configuration example of a liquid crystal dimming device according to a modification 1.

FIG. 13 is a characteristic diagram illustrating an example of a relationship between a voltage application rate and a transmittance of the liquid crystal dimming device illustrated in FIG. 12.

FIG. 14 is a diagram illustrating a configuration example of an optical system in an image pickup apparatus provided with a barrel unit according to a modification 2.

### DESCRIPTION OF EMBODIMENTS

An embodiment of the present disclosure will be described below with reference to the accompanying drawings. Note that descriptions will be given in the following order.

1. Embodiment (an example of an image pickup apparatus provided with a barrel unit including a plurality of lens groups)

### 2. Modifications

Modification 1 (an example of a liquid crystal dimming device configured of a plurality of liquid crystal layers stacked)

Modification 2 (an example of an image pickup apparatus provided with a barrel unit including one lens group)

### Embodiment

### [Overall Configuration of Image Pickup Apparatus 1]

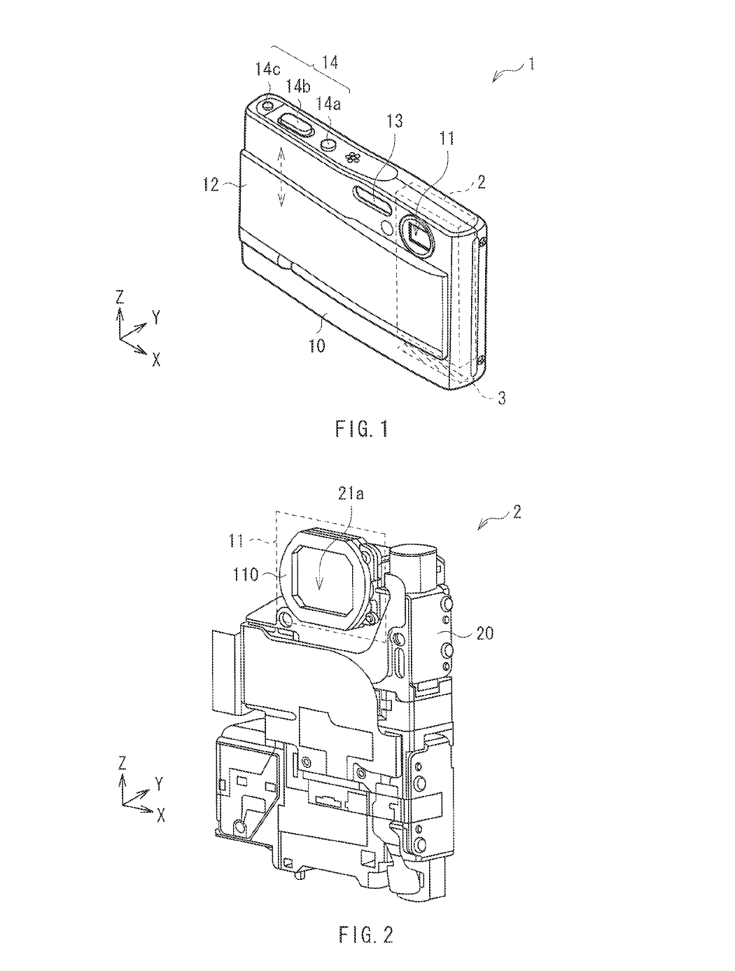

FIG. 1 is a perspective view illustrating an overall configuration (an appearance configuration) of an image pickup apparatus (an image pickup apparatus 1) according to an embodiment of the present disclosure. The image pickup apparatus 1 is a digital camera (a digital still camera) converting an optical image from an object into an electrical signal by an image pickup device (an image pickup device 3 described later). Note that an image pickup signal (a digital signal) thus obtained is allowed to be recorded in a semiconductor recording medium (not illustrated) and to be displayed on a display (not illustrated) such as a liquid crystal display.

In the image pickup apparatus 1, a lens section 11, a lens cover 12, a flash 13, and an operation button 14 are provided on a main body section 10 (a housing). Specifically, the lens section 11, the lens cover 12, and the flash 13 are disposed on a front surface (a Z-X plane) of the main body section 10, and the operation button 14 is disposed on a top surface (an X-Y plane) of the main body section 10. The image pickup apparatus 1 further includes a barrel unit 2 (a lens barrel unit) including the above-described lens section 11, the image pickup device 3, and an unillustrated control processing section (a control processing section 4 described later) in the main body section 10. Incidentally, in addition thereto, a battery, a microphone, a speaker, and the like (all not illustrated) are provided in the main body section 10.

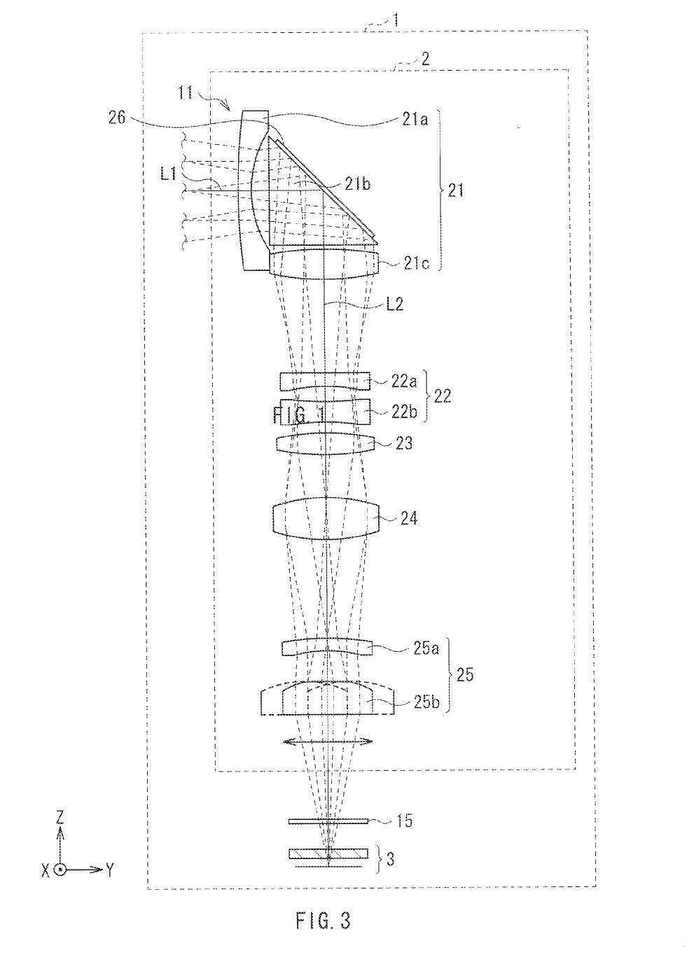

The barrel unit 2 is a so-called bending (folding) type barrel unit that emits image-pickup light that has entered the barrel unit 2, after bending an optical path of the image-pickup light, as will be described later. This enables achievement of reduction in thickness (reduction in thickness in a Y-axis direction) of the barrel unit 2. The barrel unit 2 has an appearance configuration illustrated in FIG. 2, for example. Specifically, in the barrel unit 2, the above-described lens section 11 is disposed on a top (an end in a positive direction on a Z-axis) of a tubular member 20. The lens section 11 includes a lens 21a serving as an objective lens described later, and a front frame 110 configuring a part of the main body section 10. Note that the detailed configuration of the barrel unit 2 will be described later (FIG. 3 to FIG. 5).

The image pickup device 3 is a device detecting image-pickup light emitted from the barrel unit 2 to acquire an image pickup signal. The image pickup device 3 is configured using an imaging sensor such as a CCD (charge-coupled device) and a CMOS (complementary metal-oxide semiconductor).

The lens cover 12 is a member protecting the lens section 11 from the outside, and as illustrated by a dashed arrow in the figure, is movable along the Z-axis direction. Specifically, in picking up an image of an object, the lens cover 12 is so located on a lower side of the lens section 11 as to allow the lens section 11 to be exposed on the outside. On the other hand, the lens cover 12 is so located over the lens section 11 as to allow the lens section 11 not to be exposed on the outside at times other than a time of picking up an image.

In this example, the operation button 14 includes a power button 14a turning on or off the power of the image pickup apparatus 1, a recording button 14b (a shutter button) for performing image pickup of an object, and a stabilizer setting button 14c for executing a predetermined image blurring correction to an image pickup signal. Note that buttons for executing other operations may be provided on the main body section 10 in addition to (or instead of) these buttons.

[Detailed Configuration of Barrel Unit 2]

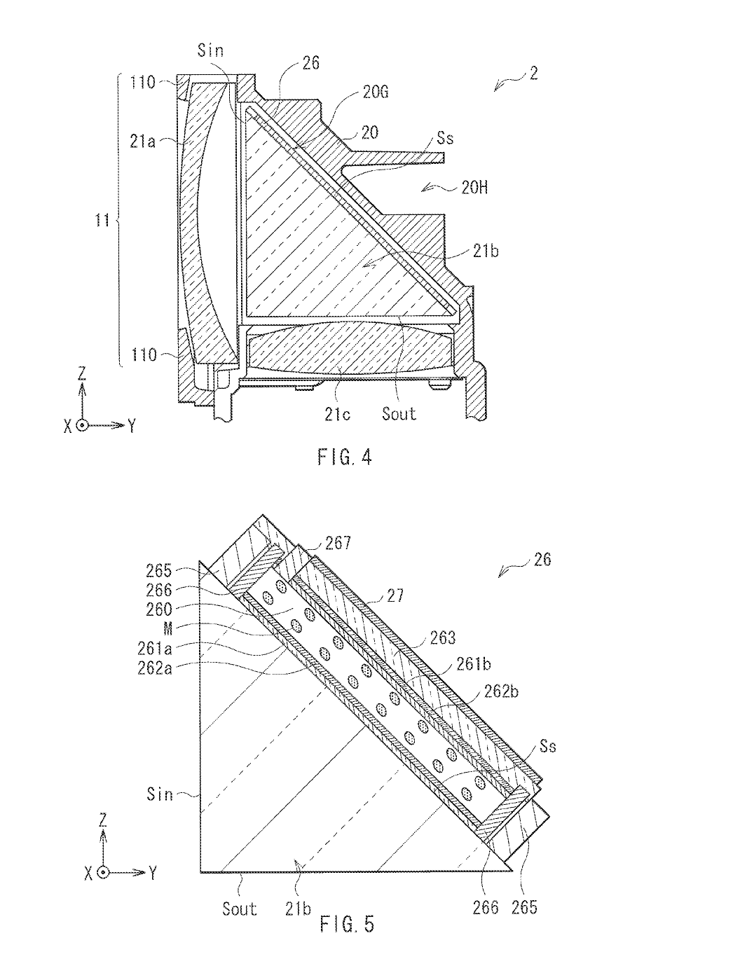

Next, the detailed configuration of the barrel unit 2 is described with reference to FIG. 3 to FIG. 5. FIG. 3 illustrates a configuration example of an optical system in the barrel unit 2, together with the image pickup device 3 and others. FIG. 4 is a sectional diagram (a Y-Z sectional diagram) illustrating a part of the barrel unit 2 illustrated in FIG. 3 in an enlarged manner.

As illustrated in FIG. 3, the barrel unit 2 includes five lens groups (a first lens group 21, a second lens group 22, a third lens group 23, a fourth lens group 24, and a fifth lens group 25), and a liquid crystal dimming device 26 (a dimming device). Of the five lens groups (group lenses), the first lens group 21 is disposed on an optical axis L1 along the Y axis and on an optical axis L2 along the Z axis, and the second to fifth lens groups 22 to 25 are disposed along the optical axis L2. In addition, the second to fifth lens groups 22 to 25 are disposed on an optical path between the first lens group 21 (the liquid crystal dimming device 26) and the image pickup device 3, in this order from the first lens group 21 side. Incidentally, in this example, a predetermined optical film 15 is disposed between the barrel unit 2 and the image pickup device 3 (between the fifth lens group 25 (a lens 25b described later) and the image pickup device 3).

The first lens group 21 includes a lens 21a disposed on an optical axis L, a prism 21b, and a lens 21c disposed on the optical axis L2. The lens 21a is a lens functioning as an objective lens as described above, and receives image-pickup light of an object. The prism 2 lb is disposed in a bending region (in a bending region of the optical path of the image-pickup light) in the barrel unit 2, and has a triangular prism shape including an incident surface (a Z-X plane) and an emission surface (a X-Y plane) of the image-pickup light, and an inclined surface (a mounting surface, a forming surface, or a reflection surface of the liquid crystal dimming device 26). In other words, the prism 21b is a right angle prism allowing the image-pickup light incident along the optical axis L1 to be emitted along the optical axis L2 after bending (folding) the optical path of the image-pickup light. Accordingly, the barrel unit 2 functions as a bending (folding) type barrel unit as described above. The lens 21c is a lens disposed on the emission surface side of the prism 21b. Incidentally, in contrast thereto, the lens 21a is disposed on the incident surface side of the prism 21b.

The second lens group 22 includes two lenses 22a and 22b disposed on the optical axis L2. These lenses 22a and 22b are each movable in, for example, a wide direction (a wide-angle direction) and a tele direction (a telescopic direction) on the optical axis L2.

In this example, the third lens group 23 includes one lens that is fixedly disposed in the barrel unit 2.

In this example, the fourth lens group 24 includes one lens that is movable on the optical axis L2. The lens configuring the fourth lens group 24 is a lens (a focus lens) used for adjusting a focal length (for focusing).

The fifth lens group 25 includes two lenses 25a and 25b disposed on the optical axis L2. The lens 25a is fixedly disposed in the barrel unit 2, whereas the lens 25b (a correction lens) is movable in the Y-axis direction as illustrated by an arrow and a dashed line in the figure.

In this example, the second lens group 22 and the fourth lens group 24 are independently movable along the optical axis L2 in the tele direction and the wide direction. Movement of the second lens group 22 and the fourth lens group 24 in the tele direction or the wide direction causes zoom adjustment and the focus adjustment. Specifically, in zooming, zoom adjustment is performed by movement of the second lens group 22 and the fourth lens group 24 from the wide (wide-angle) direction to the tele (telescopic) direction. In addition, in focusing, focus adjustment is performed by movement of the fourth lens group 24 from the wide direction to the tele direction.

(Liquid Crystal Dimming Device 26)

The liquid crystal dimming device 26 is a device (a dimming device) adjusting a light amount of the image-pickup light, and electrically performs light amount adjustment (dimming) with use of a liquid crystal. As illustrated in FIG. 3, the liquid crystal dimming device 26 is disposed in the above-described bending region of the optical path of the image-pickup light.

Specifically, as illustrated in FIG. 4, the liquid crystal dimming device 26 is disposed (formed) on an inclined surface Ss of the prism 21b that includes an incident surface Sin, an emission surface Sout, and the inclined surface Ss. In detail, the liquid crystal dimming device 26 is disposed in a gap (a gap region) 20G (a space region) between the internal surface of the tubular member 20 and the prism 21b (the inclined surface Ss). Note that, as illustrated in the figure, a positioning hole 20H (a boss hole) used at a time when the barrel unit 2 is attached to the main body section 10 of the image pickup apparatus 1 is formed along the Y-axis direction, on a back surface side (the inclined surface Ss side) of the prism 21b in the tubular member 20.

FIG. 5 schematically illustrates a detailed sectional configuration example (the Y-Z sectional configuration example) of the liquid crystal dimming device 26, together with the prism 21b and others. The liquid crystal dimming device 26 has a stacked structure in which a transparent electrode 261a, an alignment film 262a, a liquid crystal layer 260, an alignment film 262b, a transparent electrode 261b, and a transparent substrate 263 are stacked in this order from the prism 21b side. The liquid crystal dimming device 26 further includes a sealing agent 265, a spacer 266, and a sealing section 267. In addition, a reflective film 27 (a reflective section) is provided on a side of the liquid crystal dimming device 26 opposite to the prism 21b (on the internal surface side of the tubular member 20). In other words, in the barrel unit 2, the liquid crystal dimming device 26 is disposed between the prism 21b and the reflective film 27.

The liquid crystal layer 260 is a layer containing liquid crystal molecules, and in this case, containing predetermined pigment molecules (dichroic dye molecules), in addition to the liquid crystal molecules (in FIG. 5, liquid crystal molecules and pigment molecules are collectively illustrated as “molecule M” for simplifying illustration). In other words, the liquid crystal dimming device 26 is configured using a guest-host (GH) type liquid crystal containing pigment (dichroic pigment).

Such a GH type liquid crystal (the GH liquid crystal) is roughly classified into a negative type and a positive type by a difference of a long-axis direction of liquid crystal molecules at the time of voltage application. In the positive GH liquid crystal, the long-axis direction of the liquid crystal molecule is perpendicular to the optical axis at the time of no voltage application, and is parallel to the optical axis at the time of voltage application. On the other hand, in the negative GH liquid crystal, inversely, the long-axis direction of the liquid crystal molecule is parallel to the optical axis at the time of no voltage application and is perpendicular to the optical axis at the time of voltage application. In this case, since the pigment molecules are aligned in the same direction as that of the liquid crystal molecules, when the positive liquid crystal is used as a host, light transmittance becomes relatively low (light emission side becomes relatively dark) at the time of no voltage application, and the light transmittance becomes relatively high (the light emission side becomes relatively bright) at the time of voltage application. On the other hand, when the negative liquid crystal is used as a host, in contrast, the light transmittance becomes relatively high (the light emission side becomes relatively bright) at the time of no voltage application, and the light transmittance becomes relatively low (the light emission side becomes relatively dark) at the time of voltage application. Noted that, in the present embodiment, although the liquid crystal layer 260 may be configured of any of the positive liquid crystal and the negative liquid crystal, the case where the liquid crystal layer 260 is configured of the negative liquid crystal will be described below as a representative.

Such a liquid crystal layer 260 is desirably configured using a liquid crystal having an optical refractive index substantially equal to (preferably same as) that of the prism 21b. In other words, it is desirable that the optical refractive index of the prism 21b be substantially equal to (preferably same as) that of the liquid crystal layer 260. This is because the image-pickup light is accordingly avoided from being refracted (reflected) by an interface between the prism 21b and the liquid crystal dimming device 26 (the liquid crystal layer 260), and the optical path of the image-pickup light is avoided from being deviated from the optical axes L1 and L2. Note that influence by optical refraction indices of the other members (such as the transparent electrodes 261a and 261b and the alignment films 262a and 262b) in the liquid crystal dimming device 26 may substantially not be considered from the following reasons. First, this is because the thickness of each of the members is extremely small (about several tens nm to about several hundreds nm). In addition, the optical refractive index of each of the alignment films 262a and 262b is generally set to be substantially equal to that of the liquid crystal layer 260, and the optical refractive index of each of the transparent electrodes 261a and 261b is allowed to be easily adjusted by adjustment of the thickness thereof.

Each of the transparent electrodes 261a and 261b is an electrode applying a voltage (a drive voltage) to the liquid crystal layer 260, and is formed of, for example, indium tin oxide (ITO). Incidentally, wirings (not illustrated) electrically connected to the transparent electrodes 261a and 261b may be appropriately arranged.

Each of the alignment films 262a and 262b is a film allowing the liquid crystal molecules in the liquid crystal layer 260 to be aligned in a desired direction (alignment direction). The alignment films 262a and 262b are each formed of, for example, a polymer material such as polyimide, and rubbing treatment is previously performed thereon in a predetermined direction, thereby setting the alignment direction of the liquid crystal molecules.

The transparent substrate 263 is a substrate on one side to support the transparent electrode 261b, the alignment film 262b, and the reflective film 27 as well as to seal the liquid crystal layer 260, and is formed of, for example, a glass substrate. Incidentally, in this case, although a substrate on the other side to support the transparent electrode 261a and the alignment film 262a as well as to seal the liquid crystal layer 260 is configured of the prism 21b, a transparent substrate may be further provided between the prism 21b and the transparent electrode 261a, instead of the prism 21b. However, it is desirable that the prism 21b double as such a substrate on the other side because the number of components of the liquid crystal device 26 is decreased.

The reflective film 27 is disposed on the tubular member 20 (the internal surface) side (on a side opposite to the liquid crystal layer 260) of the transparent substrate 263, and although the detail thereof will be described later, is a film having a function of reflecting (totally reflecting) image-pickup light. Such a reflective film 27 is formed of a metal material such as aluminum (Al) and silver (Ag), or an alloy thereof.

The sealing agent 265 is a member to seal the molecules M (the liquid crystal molecules and the pigment molecules) in the liquid crystal layer 260 from side surface sides, and is formed of an adhesive such as an epoxy adhesive and an acrylic adhesive. The spacer 266 is a member to maintain a constant cell gap (the constant thickness) of the liquid crystal layer 260, and is formed of, for example, a predetermined resin material or a predetermined glass material. The sealing section 267 is an enclosure port to enclose the molecules M into the liquid crystal layer 260, and thereafter, to seal the molecules M in the liquid crystal layer 260 from the outside.

[Block Configuration of Control Processing Section 4]

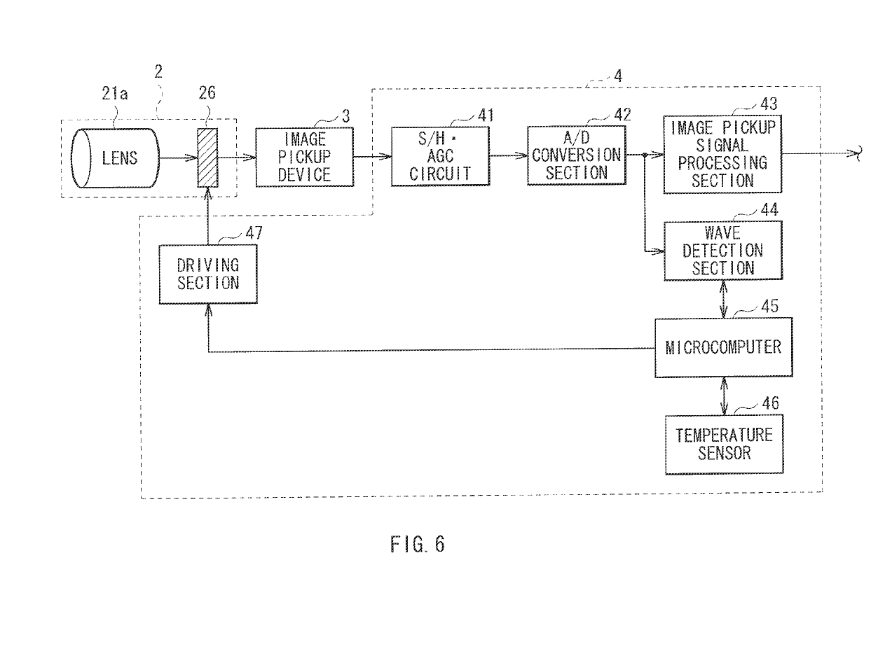

Subsequently, the configuration of the above-described control processing section 4 is described. FIG. 6 illustrates the block configuration of the control processing section 4 together with the barrel unit 2 and the image pickup device 3. Note that, as for the inside of the barrel unit 2 and the periphery thereof, the configuration of a part is illustrated as a representative for simplification of illustration.

The control processing section 4 performs predetermined signal processing on the image pickup signal obtained by the image pickup device 3, and performs predetermined feedback control on the liquid crystal dimming device 26 in the barrel unit 2, as will be described below. The control processing section 4 includes an S/H•AGC circuit 41, an A/D conversion section 42, an image pickup signal processing section 43, a wave detection section 44, a microcomputer 45, a temperature sensor 46, and a driving section 47.

The S/H•AGC circuit 41 is a circuit performing S/H (sample and hold) processing on the image pickup signal output from the image pickup device 3, and performing predetermined signal amplification processing with use of an AGC (automatic gain control) function.

The A/D conversion section 42 performs A/D conversion (analog to digital conversion) processing on the image pickup signal on the image pickup signal output from the S/H•AGC circuit 41 to generate an image pickup signal configured of a digital signal.

The image pickup signal processing section 43 performs predetermined signal processing (such as image quality improvement processing) on the image pickup signal (the digital signal) output from the A/D conversion section 42. The image pickup signal subjected to the signal processing in this way is output to the outside of the image pickup processing section 43 (unillustrated semiconductor recording medium and the like).

The wave detection section 44 performs predetermined AE wave detection on the image pickup signal (the digital signal) output from the A/D conversion section 42, and outputs a detected value at that time.

The temperature sensor 46 is disposed in the vicinity (in the peripheral region) of the liquid crystal dimming device 26, and a sensor detecting the temperature of the liquid crystal dimming device 26. Note that temperature information of the liquid crystal dimming device 26 detected in such a way is output to the microcomputer 45.

The microcomputer 45 supplies a control signal (specifically, a voltage application amount) of the liquid crystal dimming device 26 to the driving section 47 to control the dimming operation (light amount adjusting operation) of the liquid crystal dimming device 26. Specifically, the microcomputer 45 sets the voltage amount applied to the liquid crystal dimming device 26, based on the detected value supplied from the wave detection section 44. Moreover, the microcomputer 45 has a function of executing a predetermined temperature correction (temperature correction of a voltage application amount) using temperature information of the liquid crystal dimming device 26 output from the temperature sensor 46, with use of data indicating a “correspondence relationship between temperature and amount of transmitted light” held in advance on unillustrated storage section (a memory).

The driving section 47 performs driving operation of the liquid crystal dimming device 26, based on the control signal (the voltage application amount) supplied from the microcomputer 45. Specifically, the driving section 47 applies the set voltage between the transparent electrodes 261a and 261b in the liquid crystal dimming device 26 through unillustrated wirings.

[Function and Effects of Image Pickup Apparatus 1]

### (1. Image Pickup Operation)

In the image pickup apparatus 1, the operation button 14 illustrated in FIG. 1 is operated by a user such that an image of an object is picked up and a picked-up image (image pickup data) is obtained. Specifically, as illustrated in FIG. 1 to FIG. 3, the image-pickup light enters the barrel unit 2 through the lens section 11, the optical path of the image-pickup light is then bent (folded) in the barrel unit 2. Thereafter, the resultant image-pickup light is emitted to and detected by the image pickup device 3. In the barrel unit 2, as specifically illustrated in FIG. 3, first, the image-pickup light which has entered the prism 21b along the optical path L1 through the lens 21a (an objective lens) is reflected by the reflective film 27 on the inclined surface Ss of the prism 21b. The reflected light is emitted along the optical axis L2 through the lens 21c. Then, the image-pickup light serving as the reflective light passes through the second to fifth lens groups 22 to 25 in this order, and is emitted from the barrel unit 2. The image-pickup light emitted from the barrel unit 2 enters the image pickup device 3 through the optical film 15, and is then detected. The control processing section 4 illustrated in FIG. 6 performs the above-described predetermined signal processing on the image pickup signal obtained in this way by the image pickup device 3. In addition, the control processing section 4 performs the above-described predetermined feedback control on the liquid crystal dimming device 26 in the barrel unit 2, based on the obtained image pickup signal.

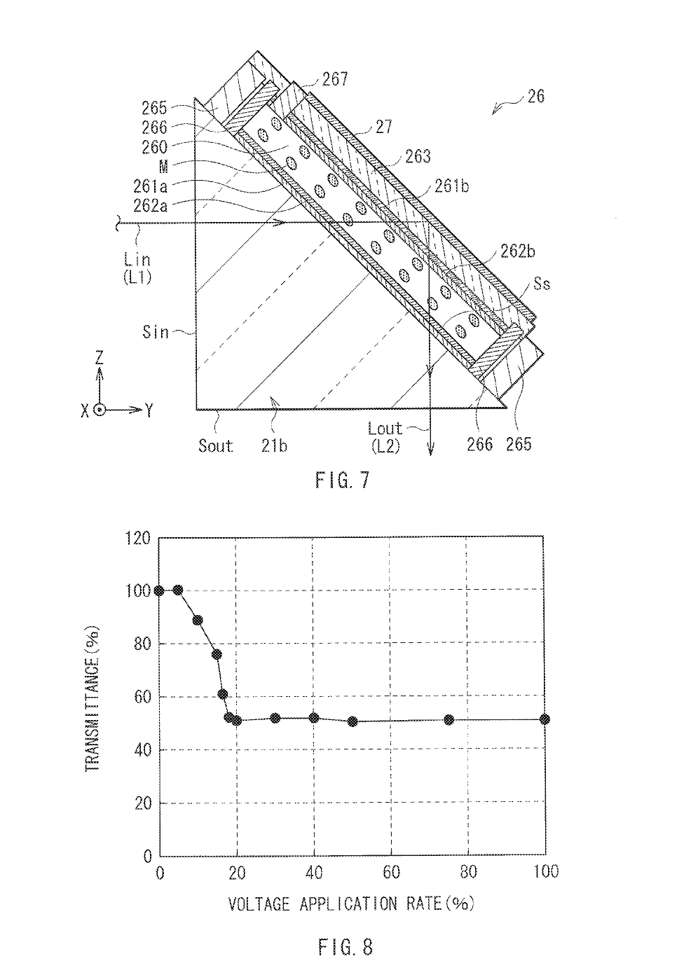

At this time, in the liquid crystal dimming device 26, the image-pickup light (the incident light Lin) which has entered the prism 21b from the incident surface Sin thereof passes through the liquid crystal layer 260 and the like through the prism 21b, and is then reflected (totally reflected) by the reflective film 27, as specifically illustrated in FIG. 7. Then, the reflected image-pickup light passes through the liquid crystal layer 260 and the like again, and is emitted as the emission light Lout from the emission surface Sout of the prism 21b. At this time, when a predetermined voltage (the drive voltage) is applied to the liquid crystal layer 260, the alignment direction (the long axis direction) of the molecules M (the liquid crystal molecules and the pigment molecules) changes, and amount of the image-pickup light passing through the liquid crystal layer 260 accordingly changes. Therefore, adjusting the drive voltage at this time enables electrical (not mechanical) adjustment of the amount of the image-pickup light passing through the entire liquid crystal dimming device 26 (enables arbitrary dimming operation). As described above, light amount adjustment (dimming) is performed on the image-pickup light in the barrel unit 2

In this case, FIG. 8 illustrates an example indicating a relationship between the voltage application rate (0%: no voltage applied state, 100%: maximum voltage applied state) and the transmittance (light transmittance) of the liquid crystal dimming device 26. In this example, a negative GH liquid crystal is used in the liquid crystal layer 260, and the amount of the transmitted image-pickup light in the no voltage applied state (0 V state) is a reference amount (100%). It is found from FIG. 8 that light blocking amount by the liquid crystal layer 260 is rapidly increased (the transmittance is rapidly decreased) with increasing the voltage application rate, and when the voltage application rate is about 20%, the transmittance is converged to about 50% (substantially constant value). In other words, in the example, the dimming range (the dynamic range) of the liquid crystal dimming device 26 is about 50% (the transmittance is within a range of 100% to 50%). The value, the gradient, and the dimming range in the transmittance change of the liquid crystal dimming device 26 are changed depending on the material and the concentration of (the liquid crystal and the pigment of) the liquid crystal layer 260, the cell gap (the thickness) of the liquid crystal layer 260, the kind (the material) of the alignment films 262a and 262b, and the like. Incidentally, when the positive GH liquid crystal is used in the liquid crystal layer 260, there is a tendency that the transmittance is low in the no voltage applied state (the voltage application rate is equal to 0%) and the transmittance is increased with increasing the voltage application rate, contrary to the characteristics in FIG. 8.

(2. Function of Features)

Next, a function of the features of the image pickup apparatus 1 will be described in detail with comparison with a comparative example.

### Comparative Example

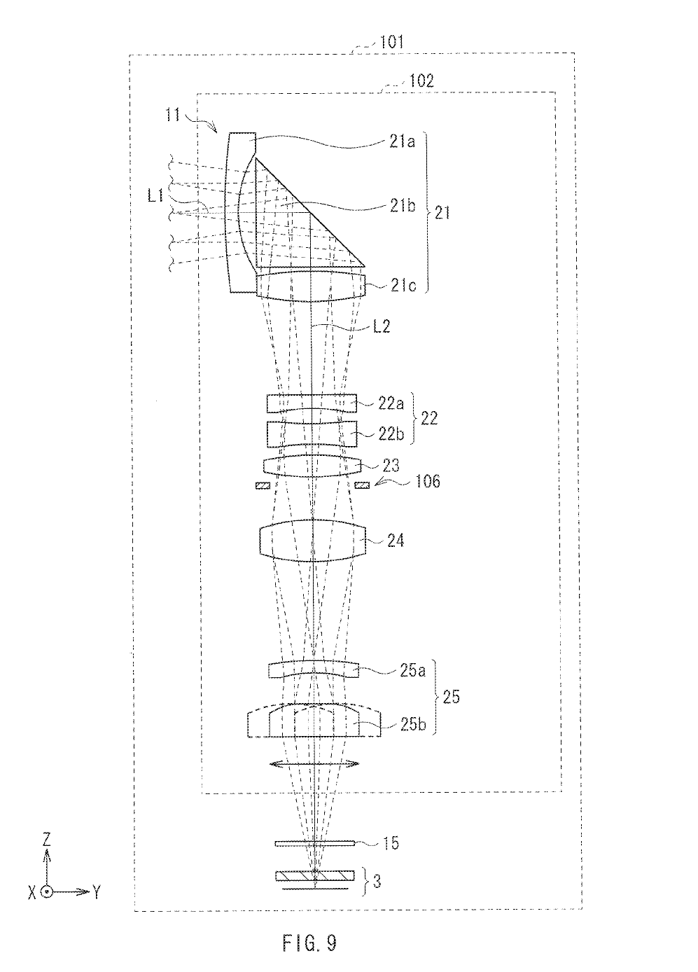

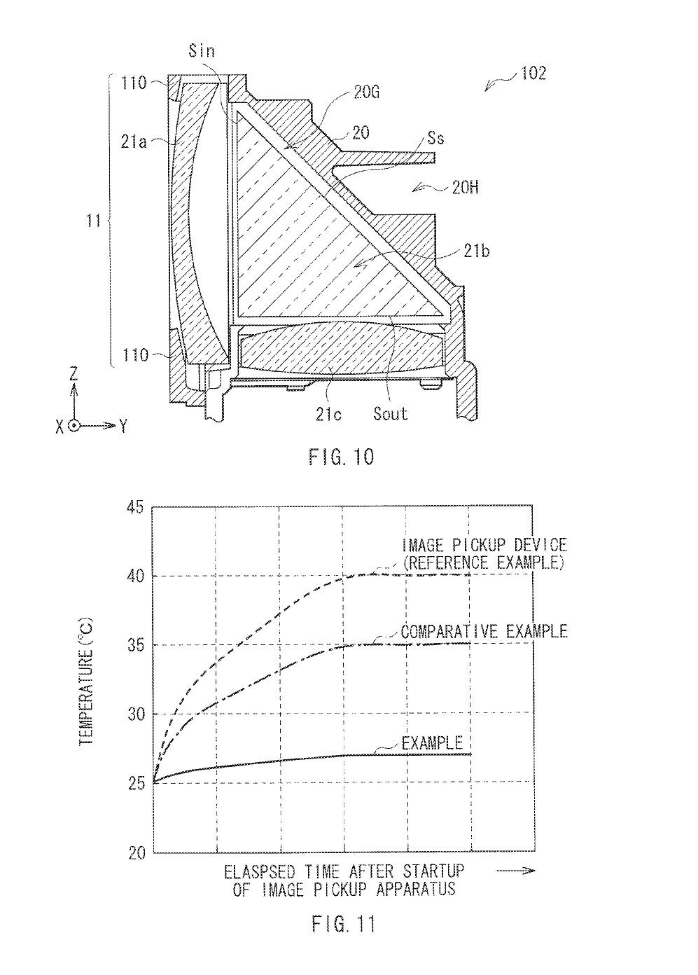

FIG. 9 illustrates a configuration example of an optical system in an image pickup apparatus (an image pickup apparatus 101) including an existing barrel unit (a barrel unit 102) according to a comparative example. In addition, FIG. 10 is a sectional diagram (a Y-Z sectional diagram) illustrating a part of the barrel unit 102 in an enlarged manner. The image pickup apparatus 101 according to the comparative example includes the barrel unit 102, the optical film 15, and the image pickup device 3. In other words, the barrel unit 102 is provided instead of the barrel unit 2 in the image pickup apparatus 1 according to the present embodiment illustrated in FIG. 3.

The barrel unit 102 corresponds to the barrel unit provided with a mechanical dimming device (an iris diaphragm) 106 instead of the above-described liquid crystal dimming device 26 in the barrel unit 2 according to the present embodiment illustrated in FIG. 3. Therefore, as illustrated in FIG. 10, unlike the barrel unit 2, the liquid crystal dimming device 26 is not disposed in the gap 20G between the internal surface of the tubular member 20 and the prism 21b (the inclined surface Ss) in the barrel unit 102. On the other hand, the dimming device 106 is disposed on the optical path (the optical axis L2) between the third lens group 23 and the fourth lens group 24.

As described above, in the barrel unit 102 of the comparative example, the dimming device 106 is disposed in a region on the image pickup device 3 side in the barrel unit 102 (on the optical path between the bending region and the image pickup device 3). However, in the mechanical dimming device 106, an installation space for iris blades and an installation space for a driving mechanism thereof are both made large. Therefore, it is disadvantageous in size reduction (in thickness reduction) of the barrel unit 102.

Therefore, it is conceivable that an electrical dimming device (a liquid crystal dimming device) using GH liquid crystal is disposed as the liquid crystal dimming device 26 of the present embodiment, instead of the mechanical dimming device 106. When the liquid crystal dimming device is disposed as it is in the installation region of the dimming device 106 described above, however, although the size reduction (thickness reduction) of the barrel unit 102 is achieved as compared with the mechanical dimming device 106, it is insufficient to achieve further size reduction. Specifically, with this configuration, even if the liquid crystal dimming device itself is reduced in thickness by optimization of the components thereof and the like, the length of the optical path of the image-pickup light (the length of the lens) up to the image pickup device is increased by the amount of the installation space of the liquid crystal dimming device. Accordingly, in the image pickup apparatus 101 using the bending type barrel unit 102 according to the comparative example, there is a limit to achieve reduction in size when the dimming device is disposed in the barrel unit 102.

Moreover, as described above, in the barrel unit 102 of the comparative example, when the liquid crystal dimming device using the GH liquid crystal is disposed in the installation region of the dimming device 106, influence of temperature rise of the image pickup device 3 is disadvantageously increased. Specifically, first, it is known that, in the GH liquid crystal, since the liquid crystal as a host has temperature dependency, responsiveness and tilt amount (tilt angle when a voltage is applied) of the liquid crystal are varied according to variation of the ambient temperature (environment temperature). Therefore, the liquid crystal dimming device using such a GH liquid crystal is necessary to be subjected to various correction processing (temperature correction processing) at the time of light amount adjustment (dimming) operation. In addition, the image pickup device 3 generates heat extremely easily (the temperature of the device is increased easily) when the image pickup apparatus 101 is activated. Accordingly, in the barrel unit 102 of the comparative example, since the distance between the image pickup device 3 and the dimming device 106 (the liquid crystal dimming device) is small as described above, the dimming device 106 is easily affected by the heat (largely affected by the heat) generated by the image pickup device 3. Therefore, the above-described temperature correction processing is complicated, and the large deviation may occur between the corrected value and an ideal value in some cases.

(Function of Present Embodiment)

In contrast, in the barrel unit 2 of the image pickup apparatus 1 of the present embodiment, as illustrated in FIG. 4, the liquid crystal dimming device 26 is disposed in the bending region bending the optical path of the image-pickup light which has entered the barrel unit 2. Therefore, as compared with the image pickup apparatus 101 (the barrel unit 102) of the comparative example described above, the length of the optical path of the image-pickup light up to the image pickup device 3 (the length of the lens) is allowed to be reduced by the amount of the installation space (installation space on the optical axis L2) of the dimming device. Specifically, unlike the image pickup apparatus 101 of the comparative example described above, a space dedicated for installation (dedicated space) of the dimming device is unnecessary. This is because in the bending type barrel unit, generally, the positioning hole 20H is only provided on the back surface side (the inclined surface Ss side) of the prism 21b in the tubular member 20, and therefore, there is a dead space, as the barrel unit 2 of the present embodiment. Specifically, the liquid crystal dimming device 26 is disposed in the gap 20G (on the back surface side of the prism 21b) between the internal surface of the tubular member 20 and the prism 21b, and thus such a dedicated space is unnecessary. In addition, in the barrel unit 2, since the electrical dimming device (the liquid crystal dimming device 26) is used instead of the mechanical dimming device, (the installation space of) a mechanical diaphragm is also unnecessary.

Further, as illustrated in FIG. 3, in the barrel unit 2 of the present embodiment, since the liquid crystal dimming device 26 is disposed at a position away from the image pickup device 3 (at a farthermost position on the optical axis L2), the influence of the temperature rise in the image pickup device 3 described above is reduced, as compared with the barrel unit 102 of the above-described comparative example. Specifically, necessary amount of the temperature correction is decreased, and the temperature correction processing that tends to be increased in process load is simplified. Therefore, the deviation between the corrected value and an ideal value is decreased (the correction deviation is suppressed and thus, more appropriate light amount adjustment (dimming) is performed).

FIG. 11 illustrates a relationship between an elapsed time after startup of the image pickup apparatus and a temperature (the temperature in the dimming device or the image pickup device 3) in the above-described example of the present embodiment, in the above-described comparative example, and in the image pickup device 3 as a reference example. It is found from FIG. 11 that in the image pickup device 3 as the reference example, temperature rise is increased (from about 25° C. (room temperature) to about 40° C.) with time elapsed after startup as described above. It is found that, in the comparative example, the temperature in the dimming device 106 is also largely increased (from about 25° C. to about 35° C.) with the temperature rise of the image pickup device 3. In contrast, it is found that, in the example, since the liquid crystal dimming device 26 is disposed at the position away from the image pickup device 3, little temperature rise occurs (from about 25° C. to about 27° C.).

As described above, in the present embodiment, the dimming device (the liquid crystal dimming device 26) is disposed in the bending region bending the optical path of the image-pickup light that has entered the barrel unit 2. Therefore, as compared with a related art, it is possible to set the length of the optical path (the length of the lens) of the image-pickup light to short, and thus the configuration of the barrel unit 2 is decreased in size (thickness reduction is achieved). Consequently, size reduction (thickness reduction) of the image pickup apparatus using the barrel unit with the dimming device is achievable.

In addition, in the case where the optical refractive index of the prism 21b is substantially equal to the optical refractive index of the liquid crystal layer 260, multiple reflection between glasses in the liquid crystal dimming device 26 is avoided. Therefore, generation of ghost and flare is avoidable, and thus it is possible to suppress adverse effects by the dust in the device, a scratch in the alignment films 262a and 262b, and the spacer 266 to the picked-up image, to minimum.

Further, in the configuration in a related art (in the comparative example), it is desired to reduce thickness of the dimming device (the liquid crystal dimming device) itself in order to achieve thickness reduction of the barrel unit. Therefore, the glass member configuring the transparent substrate is also limited to a thin glass member. In contrast, in the present embodiment, since the liquid crystal dimming device 26 is disposed on the back surface side (the inclined surface Ss side) of the prism 21b as described above, it becomes possible to use a glass member having a large thickness, as the transparent substrate. In addition, if the positioning hole 20H is not affected, the thickness of the glass member is not necessary to be considered. Further, when a thin glass member is used as in a related art, generation of distortion and Newton ring may occur. However, a thick glass member may be used, and thus it is possible to take measures against distortion.

[Modifications]

Subsequently, modifications (modifications 1 and 2) of the above-describe embodiment will be described. Note that like numerals are used to designate substantially like components of the embodiment, and the description thereof will be appropriately omitted.

[Modification 1]

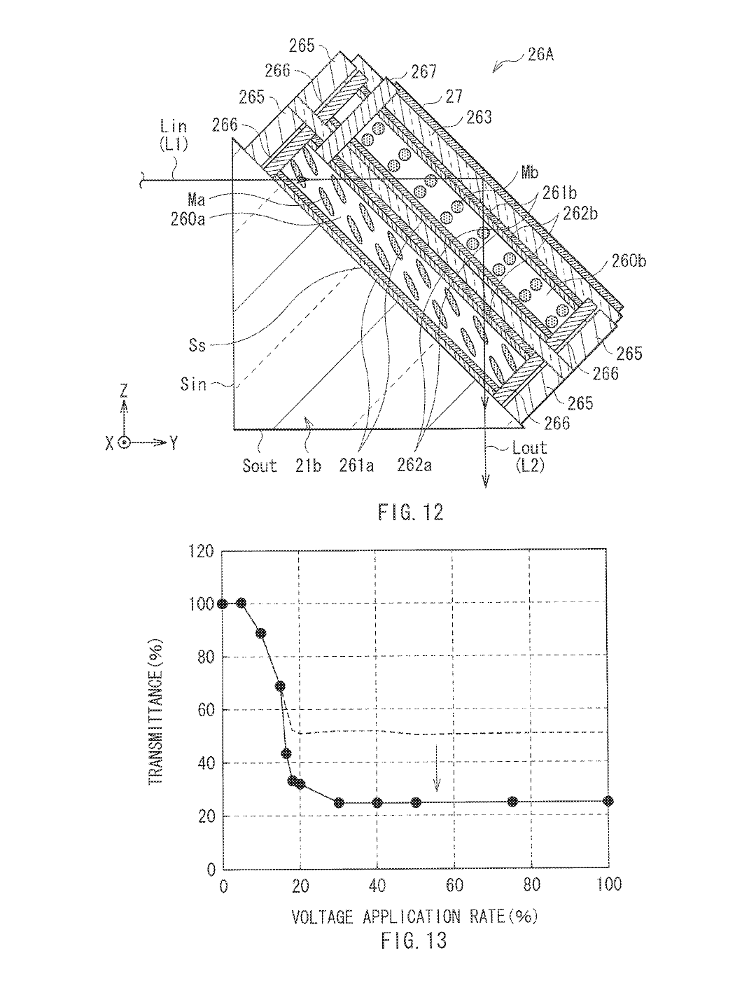

FIG. 12 schematically illustrates a cross-sectional configuration example of a liquid crystal dimming device (a liquid crystal dimming device 26A) according to the modification 1, together with the prism 21b. Unlike the liquid crystal dimming device 26 of the above-described embodiment in which the liquid crystal layer is a one-layer (single-layer) structure (the liquid crystal layer 260), in the liquid crystal dimming device 26A of the present modification, the liquid crystal layer has a two-layer (multi-layer) structure. In other words, the liquid crystal dimming device 26A is configured by stacking two liquid crystal layers 260a and 260b, as will be described in detail below.

Specifically, the liquid crystal dimming device 26A has a stacked structure in which the transparent electrode 261a, the alignment film 262a, the liquid crystal layer 260a, the alignment film 262b, the transparent electrode 261b, the transparent substrate 263, the transparent electrode 261a, the alignment film 262a, the liquid crystal layer 260b, the alignment film 262b, the transparent electrode 261b, and the transparent substrate 263 are stacked in this order from the prism 21b side. In the liquid crystal dimming device 26A, the sealing agent 265, the spacer 266, and the sealing section 267 are also provided on the side surface sides of the liquid crystal layers 260a and 260b, similarly to the liquid crystal dimming device 26. Furthermore, the reflective film 27 is also provided on a side of the liquid crystal dimming device 26A opposite to the prism 21b (on the internal surface side of the tubular member 20). In other words, the liquid crystal dimming device 26A is disposed between the prism 21b and the reflective film 27.

Each of the liquid crystal layers 260a and 260b is configured using a GH liquid crystal containing pigment (dichroic pigment), similarly to the liquid crystal layer 260. Specifically, the liquid crystal layer 260a contains molecules Ma (liquid crystal molecules and pigment molecules), and the liquid crystal layer 260b contains molecules Mb (liquid crystal molecules and pigment molecules). Incidentally, in this case, although the alignment direction (the long-axis direction) of the molecules Ma in the liquid crystal layer 260a is different from that of the molecules Mb in the liquid crystal layer 260b, this is not limitative, and the alignment direction may be arbitrarily set.

Also in the liquid crystal dimming device 26A of the present modification, it is possible to perform dimming operation similar to that of the liquid crystal dimming device 26. Specifically, image-pickup light (incident light Lin) which has entered the prism 21b from the incident surface Sin thereof passes through the liquid crystal layers 260a and 260b in this order through the prism 21b, and is then reflected (totally reflected) by the reflective film 27. After that, the reflected image-pickup light passes through the liquid crystal layers 260a and 260b and the like again in this order, and is then emitted as emission light Lout from the emission surface Sout of the prism 21b. Then, when a predetermined voltage (a drive voltage) is applied to each of the liquid crystal layers 260a and 260b at this time, the alignment directions (the long-axis directions) of the molecules Ma and Mb (the liquid crystal molecules and the pigment molecules) are changed, and the amount of the image-pickup light passing through the liquid crystal layers 260a and 260b is accordingly changed. Therefore, in the liquid crystal dimming device 26A, adjusting the drive voltage to each of the liquid crystal layers 260a and 260b at this time enables electrical adjustment of the amount of the image-pickup light passing through the entire liquid crystal dimming device 26A. Note that when the drive voltages (the applied voltages) to the liquid crystal layers 260a and 260b are different from each other, for example, a constant light amount is allowed to be maintained while polarization (polarization component) in a specific direction of the image-pickup light is intentionally weakened.

However, the liquid crystal dimming device 26A configured by stacking the two liquid crystal layers 260a and 260b as described above may provide the following effects. Specifically, first, it is known that, in the GH liquid crystal, generally, since kinds and dissolution amount of pigments dissolving to the liquid crystal as a host are limited, the dimming range by the liquid crystal dimming device is also limited to some extent. In this case, when a GH liquid crystal with a constant density is used, although it is possible to increase the dimming range by increasing the cell gap (increasing the thickness) of the liquid crystal layer, the increase of the cell gap adversely affects the response speed of the liquid crystal (the response speed of the liquid crystal is decreased). Therefore, to increase the dimming range, it is conceivable that a polarizer is used together. However, if the polarizer is fixed (the polarization axis is fixed), F-number of the lens in the image pickup apparatus is lowered. Accordingly, although it is realistic to configure the polarizer to be removable (detachable) with respect to the optical path, when a polarizer with such a configuration is used together, it is difficult to achieve space saving (reduction in thickness) of the barrel unit (further, the image pickup apparatus).

On the other hand, the liquid crystal dimming device 26A of the present modification has the above-described two-layer structure of the liquid crystal layers 260a and 260b. Therefore, it is possible to increase the dimming range while the cell gap (the thickness) of the liquid crystal layer itself is held (without change) and the response speed of the liquid crystal is maintained (not lowered).

FIG. 13 illustrates an example indicating a relationship between a voltage application rate and a transmittance of the liquid crystal dimming device 26A, similarly to FIG. 8 of the embodiment. Also in the example, the negative GH liquid crystal is used in each of the liquid crystal layers 260a and 260b, and the amount of the transmitted image-pickup light in the no voltage applied state (0 V state) is a reference amount (100%). It is found from FIG. 13 that the transmittance is converged to about 25% (substantially constant value) when the voltage application rate is about 20%. In other words, in the example, the dimming range of the liquid crystal dimming device 26A is about 75% (the transmittance is within a range of 100% to 25%), and it is found that the dimming range is increased (increased from about 50% to about 75%, see an arrow in the figure), as compared to the example of the liquid crystal dimming device 26 illustrated in FIG. 8.

Incidentally, although the case where the liquid crystal layer has the two-layer structure has been described in the present modification, this is not limitative. The liquid crystal layer in the liquid crystal dimming device may have a stacked structure of three layers or more.

[Modification 2]

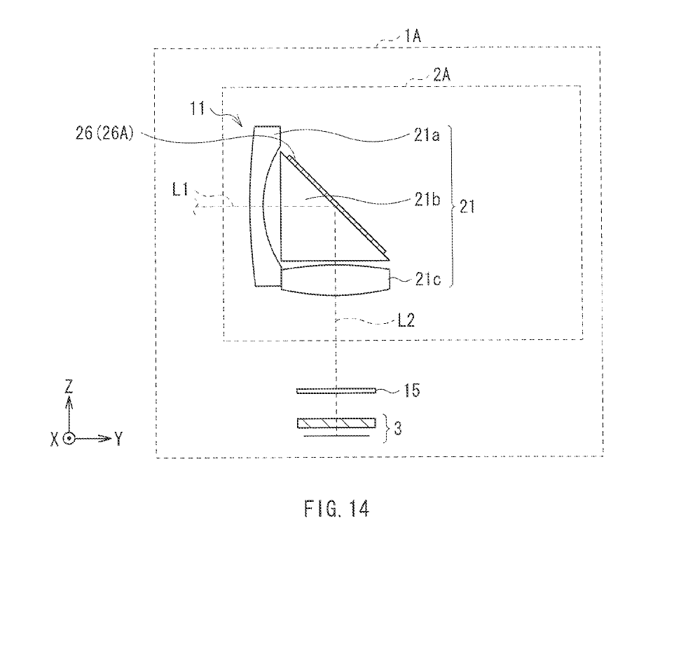

FIG. 14 illustrates a schematic configuration of an image pickup apparatus (an image pickup apparatus 1A) according to a modification 2. The image pickup apparatus 1A of the present modification has a barrel unit (a barrel unit 2A) according to the present modification described below, instead of the barrel unit 2 in the image pickup apparatus 1 of the above-described embodiment.

The barrel unit 2A of the present modification corresponds to a barrel unit obtained by omitting (not providing) the second lens group 22, the third lens group 23, the fourth lens group 24, and the fifth lens group 25 from the barrel unit 2. In other words, the barrel unit 2A is configured to include only one lens group (the first lens group 21), and has the first lens group 21 and the liquid crystal dimming device 26 (or the liquid crystal dimming device 26A).

Therefore, in the image pickup apparatus 1A of the present modification, the image-pickup light (the reflected light) which has been emitted from the lens 21c in the barrel unit 2A is directly detected by the image pickup device 3, or is detected by the image pickup device 3 through the optical film 15. As described above, it is only necessary to provide one or a plurality of lens groups on the optical path between the liquid crystal dimming device and the image pickup device in the barrel unit.

### [Other Modifications]

Hereinbefore, although the disclosure has been described with reference to the embodiment and the modifications, the disclosure is not limited to the embodiment and the like, and various modifications may be made.

For example, in the above-described embodiment and the like, although the liquid crystal dimming device using the GH liquid crystal has been described as an example, this is not limited to the case. A liquid crystal dimming device using a liquid crystal other than the GH liquid crystal may be used, and further, a dimming device other than a liquid crystal dimming device may be used.

Specifically, as the dimming device other than the liquid crystal dimming device, dimming devices of the following systems may be used. Specifically, for example, a dimming device using a gel material that is used for thermochromism (practical example: a mug, a polymer sheet, and the like) or thermotropic; a dimming device using a material in photochromic (practical example: sunglasses changed by ultra violet lays, and the like); a dimming device using hydrogen gas and the like in gasochromic (practical example: a window glass, and the like); a dimming device using WO₃ (tungsten oxide), Nb₂O₅ (niobium oxide), NiO (nickel oxide), Cr₂O₃ (chromium oxide), and the like in electrochromic (practical example: a window glass, and the like) may be used. Of these dimming devices, the dimming device using electrochromic has highest correlativity (affinity) with the configuration of the above-described embodiment and the like. The basic structure of the dimming device of this system is a stacked structure in which, for example, a transparent glass, a transparent electrode, an electrochromic material (represented by the above-described materials), a solid electrolyte, an ion storage material, and a transparent electrode are stacked in order.

Further, in the above-described embodiment and the like, the case where the prism is disposed in the bending region in the barrel unit has been described. However, depending on the case, an optical member other than the prism (for example, mirror) may be disposed in the bending region in the barrel unit.

In addition, in the above-described embodiment and the like, each component (optical system) of the barrel unit, the image pickup apparatus, and the like has been described specifically. However, all components are not necessarily provided, and other components may be further provided.

1. An image pickup apparatus comprising:
a barrel unit emitting incident image-pickup light after bending an optical path of the image-pickup light; and
an image pickup device detecting the image-pickup light emitted from the barrel unit to obtain an image pickup signal, wherein
the barrel unit includes a dimming device in a bending region of the optical path.

2. The image pickup apparatus according to claim 1, wherein
the barrel unit includes a tubular member and a prism disposed in the bending region in the tubular member, and
the dimming device is disposed in a gap between an internal surface of the tubular member and the prism.

3. The image pickup apparatus according to claim 2, wherein the prism has a triangular prism shape, the triangular prism shape including an incident surface and an emission surface of the image-pickup light, and an inclined surface.

4. The image pickup apparatus according to claim 3, wherein the dimming device is disposed in a gap between the internal surface and the inclined surface.

5. The image pickup apparatus according to any one of claims 2 to 4, wherein
the barrel unit includes a reflective section reflecting the image-pickup light, and
the dimming device is disposed between the prism and the reflective section.

6. The image pickup apparatus according to claim 5, wherein the dimming device is a liquid crystal dimming device including a plurality of liquid crystal layers stacked.

7. The image pickup apparatus according to claim 5, wherein the dimming device is a liquid crystal dimming device configured using a liquid crystal, the liquid crystal having an optical refractive index substantially equal to an optical refractive index of the prism.

8. The image pickup apparatus according to claim 5, wherein the dimming device is a liquid crystal dimming device configured using a guest-host (GH) liquid crystal, the GH liquid crystal containing dichroic pigment.

9. The image pickup apparatus according to claim 1, wherein the barrel unit includes one or a plurality of lens groups on an optical path between the dimming device and the image pickup device.
